(19) United States
(12) Patent Application Publication
(10) Pub. No.: US 2023/0176176 A1
(43) Pub. Date: Jun. 8, 2023

(54) UNDERWATER ACOUSTIC RANGING AND LOCALIZATION

(71) Applicant: BAE Systems Information and Electronic Systems Integration Inc., Nashua, NH (US)

(72) Inventor: Ashwin Sarma, East Greenwich, RI (US)

(73) Assignee: BAE Systems Information and Electronic Systems Integration Inc., Nashua, NH (US)

(21) Appl. No.: 17/539,790

(22) Filed: Dec. 1, 2021

(51) Int. Cl. G01S 5/26

(52) U.S. Cl. CPC G01S 5/26

(57) ABSTRACT

A method is provided for localizing an underwater vehicle using acoustic ranging. The method includes receiving, using an acoustic receiver, a time series signal based on one or more acoustic signals transmitted from an acoustic source having a known location; determining a travel time of the waveform from the known location of the acoustic source to the acoustic receiver; and determining a range of the underwater vehicle with respect to the acoustic source based on the travel time of the waveform and a sound speed field taken along a ray trajectory extending from the known location of the acoustic source and intersecting with the acoustic receiver at an expected arrival time and depth of the acoustic signal at the underwater vehicle.

### STATEMENT OF GOVERNMENT INTEREST

This invention was made with U.S. Government Assistance Under Contract No. N66001 16 C 4001, awarded by the United States Navy. The U.S. Government has certain rights in this invention.

### FIELD OF DISCLOSURE

The present disclosure relates to acoustic ranging, and more particularly, to techniques for determining a location of an underwater vehicle, vessel, or platform using acoustic signals.

### BACKGROUND

Acoustic ranging techniques have been developed for determining position at sea using sound waves broadcast from ships, buoys, or shoreside transmitters. Such existing techniques require knowledge of local sea conditions, such as temperature, salinity, ocean depth, and the profile of the sea floor. These techniques rely on mathematical models of the ocean environment and thus their accuracy is subject to, among other things, approximation and numerical errors, as well as errors caused by interference of the acoustic signal by other objects or other signals, which limits the ability to obtain accurate positions using these techniques. Therefore, non-trivial problems remain with respect to underwater positioning.

### BRIEF DESCRIPTION OF THE DRAWINGS

FIG. 1 shows an example environment for operating an underwater vehicle, in accordance with an embodiment of the present disclosure.

FIG. 2 is a cross-sectional planar view of the body of water in the environment of FIG. 1, in accordance with an embodiment of the present disclosure.

FIG. 3 is a schematic of ray trajectories of the transmitted acoustic signals of the environment of FIGS. 1 and 2, in accordance with an embodiment of the present disclosure.

FIGS. 4, 5 and 6 are flow diagrams of several example methods for localizing an underwater vehicle using acoustic ranging, in accordance with embodiments of the present disclosure.

FIG. 7 is a block diagram of an example system for localizing an underwater vehicle using acoustic ranging, in accordance with an embodiment of the present disclosure.

Although the following detailed description will proceed with reference being made to illustrative embodiments, many alternatives, modifications, and variations thereof will be apparent in light of this disclosure.

### DETAILED DESCRIPTION

In accordance with an embodiment of the present disclosure, a method is provided for localizing an underwater vehicle using acoustic ranging. The method includes receiving, using an acoustic receiver, at least one acoustic signal transmitted from at least one acoustic source, where each acoustic source has a known location and a known waveform that can be used to uniquely identify the respective acoustic source. The method further includes determining a set of travel times of the waveforms from the known locations of the acoustic sources to the acoustic receiver and obtaining, based on the travel time of the waveform and the known depth of the receiver, a range between the acoustic sources and the acoustic receiver. The range can be obtained, for example, by identifying, via signal processing, ray trajectories extending from a known location of the acoustic source and through a water column to a unknown location of the acoustic receiver (except for depth) that arrive at the exact travel times of the acoustic signal observed at the acoustic receiver. The ray trajectories that arrive at expected times and depth of the acoustic signal are each a horizontal (x) range away from the acoustic source. A set of ranges are used to form a single range estimate of the underwater vehicle with respect to the known location of the acoustic source, which can also be used to determine the location of the underwater vehicle if the depth of the vehicle is known and at least two different spatially separated acoustic sources are used or if the depth is unknown and at least three different acoustic sources are used. The sound speed field estimate is an estimate of the speed of sound over a given region of a body of water and is a function of various inputs such as salinity, temperature, seafloor depth and profile. The method further includes determining a three-dimensional location of the underwater vehicle based on the range between the acoustic receiver and the known location of the acoustic source(s), and an arrival angle of each ray with respect to the acoustic receiver.

### Overview

As noted above, there are non-trivial problems associated with existing techniques for determining the position of an underwater vehicle, vessel, or platform. For example, existing acoustic ranging techniques are highly prone to approximation and numerical errors, as well as errors caused by interference of the acoustic signal by other objects or other signals. Modern marine navigation systems utilize the Global Positioning System (GPS) to ascertain the current location of a vessel at sea. A GPS-enabled receiver detects radio signals transmitted by a constellation of satellites in Earth orbit at all times, providing the ability to constantly and accurately determine the location of the receiver. However, the receiver requires an unobstructed line of sight to several GPS satellites, and therefore is not suitable for submarine applications due to attenuation or blockage of the signal by the sea water. Thus, underwater vehicles must surface to acquire an accurate position fix using GPS.

In accordance with embodiments of the present disclosure, techniques are disclosed for ray-based acoustic ranging using cooperative acoustic sources. The disclosed techniques are based at least in part on i) an estimate of a planar ocean sound speed field between an acoustic source at a known location and an acoustic receiver at an unknown location (but implicitly assumed to be somewhere in that plane); ii) acoustic propagation methods for various locations in the planar ocean sound speed field; and iii) statistical signal processing methods to prepare hydrophone data received from the acoustic source in relation to the acoustic propagation methods. The techniques provide an estimator that is naturally least sensitive to fine-grained ocean information that is not available or is not accurately measurable. The disclosed techniques can be used in real time and have been demonstrated on real data to provide tactical grade aided internal navigation system (INS)-level performance without the need for such an expensive device.

It is appreciated that robust, ray-based acoustic ranging can be performed using the disclosed techniques regardless of the quality of the estimated sound speed field. For example, predictions of the amplitudes and phases of the received signals are subject to error due to the sensitivity of these predictions to actual ocean conditions as well as due to errors inherent with numerical approximation techniques. By contrast, the disclosed ray-based ranging techniques utilize only propagation delay predictions for one or more waveform arrivals in the acoustic signal. Furthermore, a ray description is viable for relatively low frequencies when considering travel time. This allows for a highly efficient summary of the ocean’s effects on ranging. The disclosed techniques utilize the expected travel times along with relevant embedded information, viz. travel times, extracted from the observed hydrophone data. In addition, as multiple ranges can be a possibility for a single observed travel time, techniques are disclosed for organically providing statistical reinforcement for the most likely range as the various observed travel times corresponding to the various signal paths arrive at the receiver. This permits a single estimate (that was shown over a large statistically significant data set) to be as good as that obtainable from an unavailable high quality expensive Doppler velocity log (DVL)-aided INS and also automatically provides a self-estimate of that estimate’s inherent variance, which is used for further processing such as fusing multiple such range estimates with other measurements as well as Kalman based tracking.

It will be appreciated that a ray-based approach for modeling how underwater sound reaches a receiver from a source is viable for at least several reasons. For example, in some applications, the conditions required to progress from a general wave equation to an Eikonal equation are satisfied if the combination of the sound speed variability and nominal excitation wavelength together satisfy certain conditions. Note that this can occur at frequencies that are even well below 1000 Hz. Specifically, the solution to the Eikonal equation, which is a non-linear partial differential equation used for estimating wave propagation, is a good approximation to the general wave equation if the fractional change in the velocity gradient dc′ over a given wavelength is small compared to c/λ₀, as stated in Officer, Charles B., et al., “Introduction to the theory of sound transmission: With application to the ocean,” McGraw-Hill (1958), p. 40. Numerous configurations and variations and other example use cases will be appreciated in light of this disclosure.

### Example Acoustic Ranging Environment

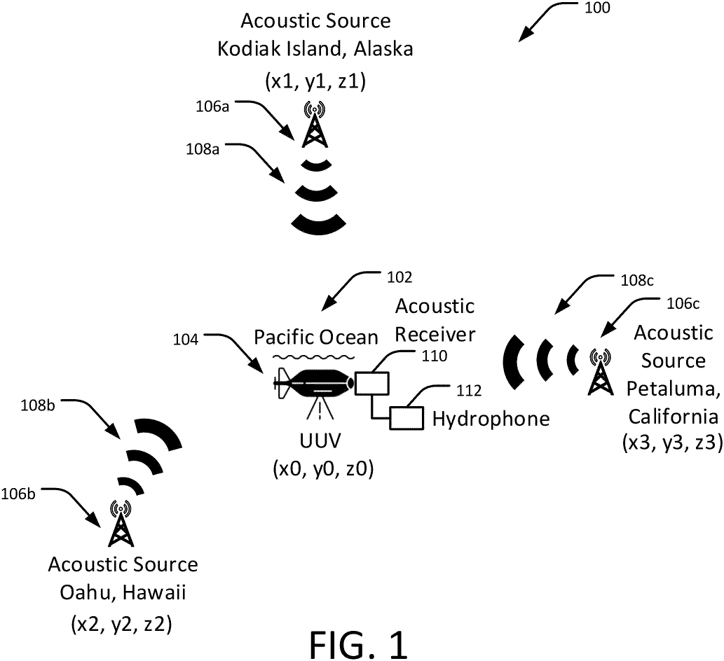

FIG. 1 shows an example environment 100 for operating an underwater vehicle 102, in accordance with an embodiment of the present disclosure. The environment includes a body of water 102, such as an ocean, an underwater vehicle, vessel, or platform 104 operating within the body of water 102 (e.g., beneath the surface), and one or more acoustic sources 106a, 106b, 106c, etc. As used herein, the term “vehicle” includes any vehicle, vessel, platform, or other object, including autonomous Unmanned Underwater Vehicles (UUVs), for which a location within the body of water 104 is to be determined. The acoustic sources 106a, 106b, 106c are located at fixed and known locations in the body of water 102. Each of the acoustic sources 106a, 106b, 106c are configured to transmit a potentially unique acoustic signal 108a, 108b, 108c through the body of water 102. Each of the acoustic signals 108a, 108b, 108c include a waveform that, when detected by a receiver, can be used to uniquely identify the respective acoustic source 106a, 106b, 106c that transmits the signal. Note that if the depth of the underwater vehicle 104 is known, a three-dimensional position of the vehicle can be determined using only two acoustic sources, and a range between the vehicle and any acoustic source can be determined using only one acoustic source.

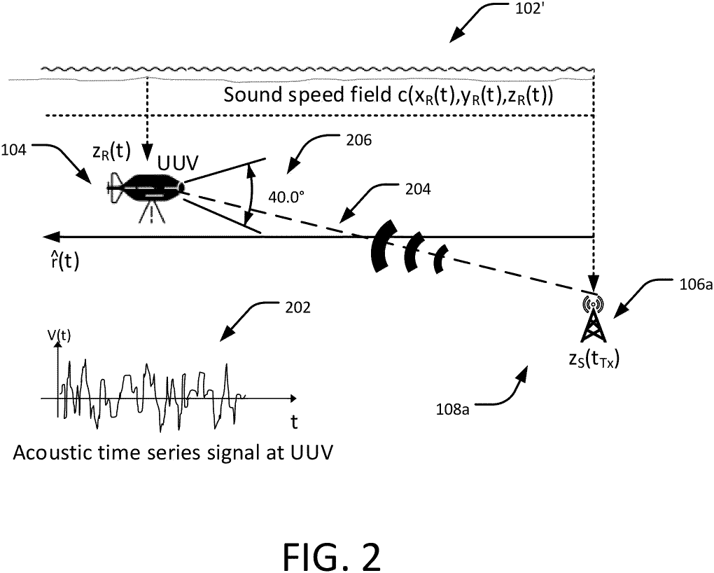

FIG. 2 is a cross-sectional planar view 102′ of the body of water 102 of FIG. 1, in accordance with an embodiment of the present disclosure. One of the acoustic sources (e.g., 106a) is shown located at a known location having a depth of z_{S}, and the vehicle 104 is shown located at an unknown location at a depth of z_{R} and at an estimated range (distance) of r̂ from the acoustic source 106a. Since the location of the vehicle 104 is initially unknown, the disclosed technique can be used to provide an acoustically derived, two-dimensional, ray-based horizontal range estimate, denoted herein as r̂(t), where t represents time. The range estimate r̂(t) represents an estimated distance between the acoustic source 106a, which is located offboard, and an acoustic receiver 110 (e.g., a hydrophone), which is located onboard the vehicle 104. The acoustic receiver 110 is coupled to at least one hydrophone 112 that is co-located at the acoustic receiver 110. In some cases, the range is time variant due to motion of the vehicle. The range estimate r̂(t) is based at least in part on a pre-provided sound speed field speed estimate, denoted herein as ĉ(x,y, z, t), and time-series signal processing of the acoustic signal 202 as received using a hydrophone (e.g., an underwater microphone) and an on-board depth sensor, if available. The range estimate r̂(t) can thus be used to determine the location of the vehicle using triangulation when multiple sources (e.g., the acoustic sources 106a, 106b, and/or 106c) having known locations and known waveforms are used, such as shown in FIG. 1. Note that the acoustic signal 202 as received at the vehicle 104 can be attenuated or otherwise modified by the effects of the body of water 102 and surrounding environment 100 as the signal travels through the water, and therefore the received signal 202 may not be the same as the transmitted signal 108a, 108b, 108c.

As discussed in further detail below, determining the location of the vehicle includes obtaining an estimate of the travel time(s) of one or more copies of the acoustic signal 106a, 106b, 106c; that is, the time it takes each signal 108a, 108b, 108c to propagate through a planar cut of the body of water 102 from the source 106a, 106b, 106c to the receiver on the vehicle 104. As noted above, if the depth of the underwater vehicle 104 is known, a three-dimensional position of the vehicle can be determined using only two acoustic sources, and a range between the vehicle and any acoustic source can be determined using only one acoustic source. A range estimate (distance from the known location of the acoustic source 106a, 106b, 106c to the vehicle 104) is produced by identifying, via signal processing, ray trajectories extending from a known location of the acoustic source(s) and through a water column to a unknown (except for depth) location of the acoustic receiver that arrive at the known depth at the exact travel times of the acoustic signal observed at the acoustic receiver. The ray trajectories that arrive at expected times and depth of the acoustic signal are each a horizontal (x) range away from the acoustic source. A set of ranges are used to form a single range estimate of the underwater vehicle with respect to the known location of the acoustic source.

As noted above, the range estimate r̂(t) is based at least in part on a pre-provided sound speed field speed estimate, denoted herein as ĉ(x, y, z, t). The sound speed field estimate is an estimation of the speed of sound in water at a given location (x, y, z) at a given time t, and particularly, the speed of sound in a specific region of water taking into account various factors such as salinity, temperature, seafloor depth and profile. For instance, the sound speed field estimate can represent an approximation of the speed of sound in the region of the ocean between the acoustic source 106a, 106b, 106c, such as a beacon, and the acoustic receiver 110, such as a hydrophone located on the vehicle 104. The sound speed field speed estimate can be obtained from any suitable source, including a database for regions of oceans where sound speed information is maintained and predicted for each day of the year, or from acoustic samples taken in situ where the distance between the source 106a, 106b, 106c and the receiver 110 is known or at least roughly known.

In addition to the sound speed field speed estimate, the range estimate is further based on i) the time series of the acoustic signal 202 observed on the hydrophone; ii) known position(s) of the acoustic sources 106a, 106b, 106c, which are fixed; iii) knowledge of the waveform of the acoustic signal 108a, 108b, 108c, such that the received signal 202 can be correlated to the original source signal 108a, 108b, 108c, and the transmission time and periodicity of the waveform (e.g., a periodic extension of a base waveform); iv) at least an estimate of the depth z_{R} of the vehicle 104 as a function of time, or knowledge of an actual depth of the vehicle 104; and v) any clock drift with respect to a synchronized and drift-free clock source.

### Time-Series Signal Processing

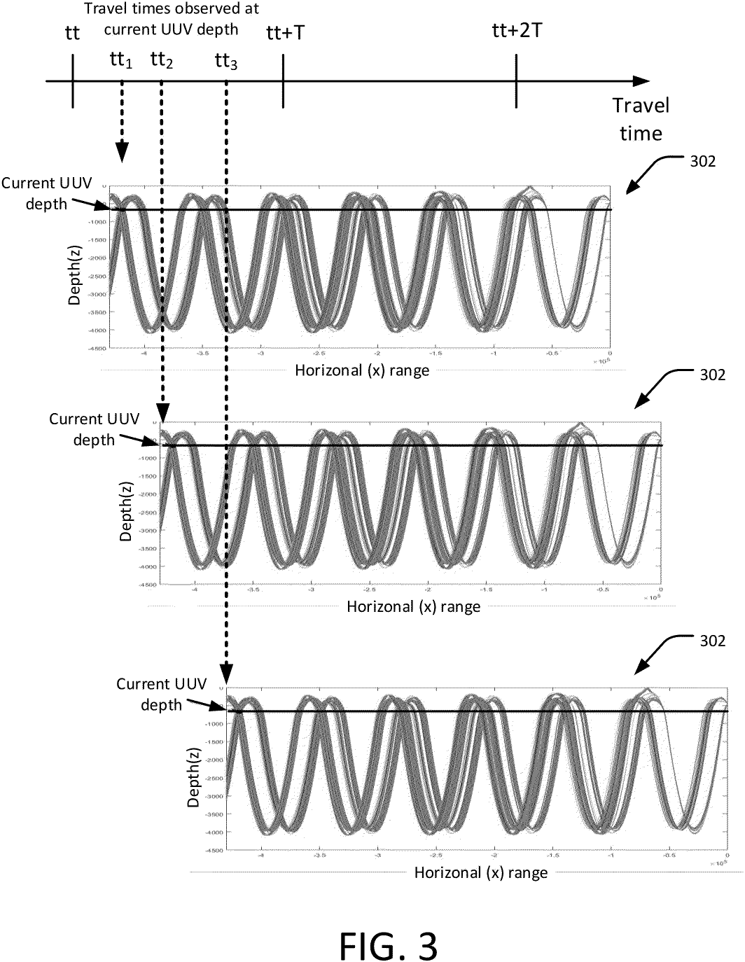

FIG. 3 is a schematic of ray trajectories 302 in one of the transmitted (source) acoustic signals 108a, 108b, 108c, in accordance with an embodiment of the present disclosure. The acoustic receiver 110, located onboard the vehicle 104, receives a time series signal 202 containing one or more potentially distorted copies of acoustic signals transmitted from one or more acoustic sources 106a, 106b, 106c, located offboard the vehicle 104. It will be understood that a single hydrophone or multiple hydrophones can be used to receive the acoustic signal 108a, 108b, 108c. Each acoustic source 106a, 106b, 106c is configured to transmit one or more waveforms that have high detectability and high delay-Doppler resolvability characteristics. Additionally, each acoustic signal 108a, 108b, 108c has a waveform that uniquely identifies the respective source 106a, 106b, 106c with a known location (e.g., (x₁, y₁, z₁)). The waveform can be periodic such that it repeats at regular intervals, for example, every T seconds, etc. Consider that around the absolute time t, the time series processing has arrived at a set of observed travel times denoted as tt₁, tt₂, ..., ttₙ of a single source’s transmission in a specific period. Note that around t + T a new set of travel times from this source may be detected if the source emits every T seconds, for example. Each of the travel times tt₁, tt₂, ..., ttₙ of a single source’s transmission in a specific period are ultimately used to generate a single range estimate of the vehicle 104 with respect to, for instance, the source 106a, the source 106b, or the source 106c (each source provides a different output). Note that each travel time, for instance tti, can generate at least one possible range hypotheses based on the specific ray trajectories that are known to leave the source with a known location at a known source transmit time (an absolute time denoted as t′) for that period and arrived at the receiver at the known depth and observed travel time (corresponding to absolute time t′ + tt1). The process repeats for tt₂ and so on to tt_{N}. N is variable and is a result of the time series processing. The median of all range hypotheses of all the qualified range estimates forms the final range estimate r̂(t) for the respective period. At least two range estimates of the vehicle 104 for a given depth at the same or later time corresponding to at least two different acoustic sources provide enough information for generating a single three-dimensional location measurement. Such information can act as a measurement (z) in a Kalman filter framework along with other measurements of the vehicle motion to estimate and refine the vehicle position as a function of time t.

In some examples, the waveforms used in the acoustic signal 108a, 108b, 108c have sufficient bandwidth to provide for pulse compression (range resolution) while remaining sensitive to Doppler effects. Specifically, the waveforms are expected to decorrelate rapidly when compared with a Doppler affected waveform and not provide biased ranging information. One such example is the Periodic-correlation Cyclic Algorithm-New (PeCAN) waveform, which is constructed by periodic extension of a base waveform that possesses a thumbtack-like ambiguity function structure. Such a waveform can have less stringent bandwidth requirements compared to other waveforms that attempt to achieve similar goals. However, it will be understood that other waveforms can be used to provide a good ambiguity function structure in a single period, such as the PeCAN and Gold waveforms having a period length of 20.47 seconds and a sub-band Gold waveform period length of 26.1 seconds. Many other suitable waveforms exist.

To determine if the expected waveform is present in the time series signal 202, the receiver 110 applies a replica correlation to the waveform(s) embedded in the received time series signal 202 by considering various Doppler effect hypotheses while stepping through the data in the time series. For example, if there is a relationship between the received waveform x[k] and an expected waveform y[k], x[k] can be correlated to y[k] by applying a Doppler shift to the y[k] zero Doppler replica. The waveform is determined to be present in the received time series signal 202 if the output of the replica correlation, or a function thereof (e.g., the absolute value of the square of the output) exceeds a signal detection threshold value. The delay-Doppler replica correlation is similar to evaluating the sample ambiguity function, which is a two-dimensional function of propagation delay and Doppler frequency that represents the distortion of the received waveform with respect to the expected waveform.

Specifically, the receiver 110 determines the waveform present in the time series signal 202 using a constant false alarm rate (CFAR) detector, where local windows are taken in both the Doppler and delay domains. CFAR is a type of adaptive, data-dependent process for detecting signals against varying background noise, clutter, and interference, as will be appreciated.

Next, the receiver 110 performs, in the time domain, clustering on the extracted waveform. Clusters are selected by applying a known waveform/wavetrain structure and a minimum allowed signal-to-noise (SNR) at the hydrophone level. In some examples, the minimum allowed SNR is approximately -20 dB. The clusters represent a set of time delay estimates within each period of the periodically extended waveforms.

The receiver 110 applies a common satellite-based time reference at both the source 106a, 106b, 106c and the receiver 110 on the vehicle 104 for translating the time delay estimates into a travel time estimate for each transmitted waveform. Time delay estimates are defined with respect to a start time. The start time of each period is defined as the transmit time at the source and is determined using a clock that synchronizes with the GPS times from satellites to produce a GMT-referenced time output. The hydrophone is sampled at Nyquist and the samples are each referenced to absolute time. This allows capture of the hydrophone time series at the receiver 110 along with simultaneous capture of the absolute time of each sample. At the source, this allows the capture of the target waveform to be transmitted along with simultaneous capture of the absolute time of each sample. The satellite-based time reference, such as in an Inter-Range Instrumentation Group IRIG-B format, can be used at all sources. If this is not available at the receiver, a Chip Scale Atomic Clock (CSAS) initially disciplined to GPS time will remain accurate with respect to GPS for long periods of time even while fully submerged. Thus, the receiver 110 translates the time delay estimates into a travel time estimate for each transmitted waveform by subtracting the absolute transmission start time of the known (correct) waveform from the absolute start time for a detected/received time delayed waveform, accounting for any clock bias or drift.

### Range Estimate

The range estimate can be obtained by identifying, via signal processing, ray trajectories extending from a known location of the acoustic source and through a water column to a unknown location of the acoustic receiver (except for depth) that arrive at the exact travel times of the acoustic signal observed at the acoustic receiver. The ray trajectories that arrive at expected times and depth of the acoustic signal are each a horizontal (x) range away from the acoustic source. A set of ranges are used to form a single range estimate of the underwater vehicle with respect to the known location of the acoustic source. A ray-based point of view is used to determine the location of the vehicle 102 in three-dimensions (x, y, z) (e.g., where x and ere x and y are rectilinear coordinates representing the naturally curved coordinate frame of latitude and longitude, and where z is depth below sea level). Several ray trajectories exist for rays 204 extending from the known source location over a range of ray trajectory angles 206 (e.g., a vertical angular sector from -20 degrees to +20 degrees with an angular spacing of 0.005 degrees). A subset of these ray trajectories intersect with a depth/travel-time qualification box defined for each of the travel time estimates. The vehicle 104 is potentially located within the depth/travel-time qualification box. In some examples, a ray casting algorithm can be used to generate the ray trajectories from a given point (e.g., the known source location of the acoustic source) through a given region.

For example, the receiver 110 can obtain a given travel time estimate τᵢ from the specific period of interest of the transmitted wavetrain along with a resolution error of the waveform (e.g., +/- 0.05 seconds), where i represents an index into a set of travel times for each period of the waveform. A set of ray trajectories can be obtained based on the three-dimensional position of the acoustic source (e.g., 106a) and an estimated depth of the hydrophone on the vehicle 104. Each of the ray trajectories from the acoustic source (e.g., 106a) that intersect the hydrophone at the estimated depth will have an associated travel time estimate τᵢ (accounting for the resolution error of the waveform). The estimate τᵢ along with the known location of the acoustic source 106a, 106b, 106c, accounting for the curvature of the Earth (which may be negligible over short distances), can be used to ultimately determine a single range hypothesis. Considering each of the travel times for a given period and the corresponding range hypotheses as a group provides a set of estimates that are summarized statistically as a single range estimate with an associated error (e.g., a sample median of each of the horizontal ranges for all associated rays 204 over all travel time estimates τᵢ, i = 1, ..., I generated for the waveform period. These single range estimates can be used alone or in combination with an imposed kinematic structure as aiding measurements in a minimum mean squared estimator (MMSE) framework.

When using the sound speed field estimate ĉ(x, y, z, t), knowledge of an approximate location of the receiver 110 can be used to slice a planar (two-dimensional) sound speed field that represents the sound speeds between the source 106a (or 106b or 106c) and the approximate receiver location on the vehicle 104. In the absence of information about the approximate receiver location, multiple radial slices are taken, and a ranging estimate is made for each slice. This leads to a range from the underwater vehicle 104 to the acoustic source (e.g., 106a) for each radial slice. After consideration of a second (different) spatially separated acoustic source (e.g., 106b), the correct three-dimensional location of the receiver location can be estimated.

Thus, working with a planar two-dimensional sound speed field slice, ray trajectories from a known three-dimensional location of the acoustic source 106a, 106b, 106c are taken outward in the direction of the receiver 110 with unknown location. For example, using a ray tracing program, R rays 204 extend over a fan of +/- D degrees (e.g., D = 20 degrees) vertical angle 206 about the horizontal, which leads to an angular spacing of 0.005 degrees and a total of 8001 rays. Each ray trajectory is quantized as a piecewise constant ray path spaced apart from other ray paths in the horizontal (x) dimension. This gives a ray trajectory database where each ray trajectory passes through underwater space that intersects, or is likely to intersect, with the known receiver depth at the known travel time. For example, for a given travel time estimate τᵢ, there can be multiple ray trajectories that leave the acoustic source at (xₛ, y_{z}, zₛ) and travel for τ seconds to the hydrophone at (xₛ, y_{z}, z₀), where τ ∈ [τᵢ - 0.05, τᵢ + 0.05] (the waveform resolution error). The overlap of the time estimate τᵢ with the interval [τᵢ - 0.05, τᵢ + 0.05] results in that ray trajectory being associated with τᵢ (note that there can be multiple such rays).

Given the approximate sufficient statistic of N travel time instances, ttₙ, where n = 1, ..., N for the given period of the wavetrain, a receiver depth/travel-time uncertainty box can be established for each travel time. The uncertainty in the travel time comes directly from the maximal expected range resolution of the transmitted waveform 302 (based on bandwidth). The expected uncertainty in receiver depth is provided by the quality of the depth sensor on board. Note that, if the receiver depth is not known, this process can be repeated for multiple depths. In this case, addition of a third unique acoustic source (e.g., 106c) can be used to estimate the three-dimensional location of the vehicle 104.

Starting with tt₁ and the corresponding depth/travel-time uncertainty box, the receiver 110 determines a subset of the ray trajectories that intersect the corresponding depth/travel-time uncertainty box. The horizontal ranges of these trajectories when the intersection occurs are noted. This is repeated for tt₂... tt_{N} and the corresponding depth/travel-time uncertainty boxes. The receiver 110 determines a range of the underwater vehicle 104 based on the median of the set of the noted horizontal ranges which acts as a single range estimate r̂(t) for a given period in the wavetrain. The standard deviation of the set of the noted horizontal ranges can be used as a bootstrap version of the standard error of r̂(t). The quantities are then time-tagged using a local clock and passed to a local process that collects them for various two-dimensional sound speed slice choices (if needed), receiver depth choices (if needed), and beacon identifiers (if needed). The quantities can also be used in a Kalman process to self-localize and self-track receiver location over time.

### Example Acoustic Ranging Methodology

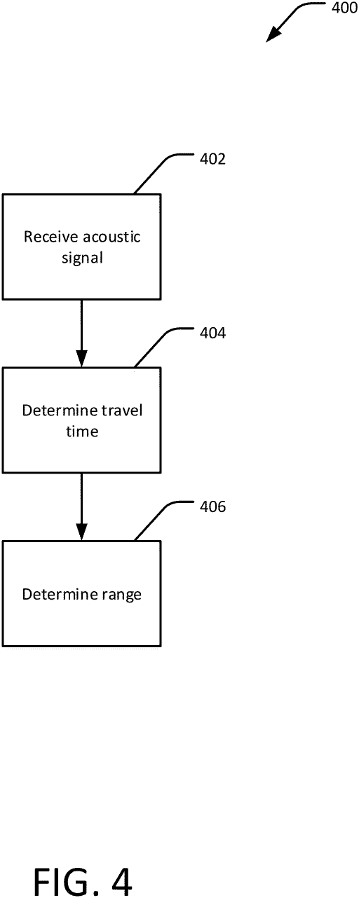

FIG. 4 is a flow diagram of an example method 400 for localizing an underwater vehicle using acoustic ranging, in accordance with an embodiment of the present disclosure. The method 400 includes receiving 402, using an acoustic receiver, a time series signal based on one or more acoustic signals transmitted from an acoustic source having a known location. The acoustic receiver can be located, for example, in an underwater vehicle, such as a UUV and coupled to a hydrophone. In some embodiments, the acoustic signal includes a waveform that can be used to uniquely identify the acoustic source. For example, each acoustic source is configured to transmit an acoustic signal with a unique waveform that is known to the acoustic receiver such that the acoustic receiver can identify the acoustic source based on the waveform. The method 400 further includes determining 404, using a processor, a travel time of the waveform from the known location of the acoustic source to the acoustic receiver. The method 400 further includes determining 406, using the processor, a range of the underwater vehicle with respect to the acoustic source based on the travel time of the waveform and a sound speed field taken along a planar (two-dimensional) ray trajectory extending from the known location of the acoustic source and intersecting with the acoustic receiver at an expected arrival time and depth of the acoustic signal at the underwater vehicle. The sound speed field speed estimate are estimates of the speed of sound along a water column between the acoustic source and the hydrophone, which is located on the vehicle.

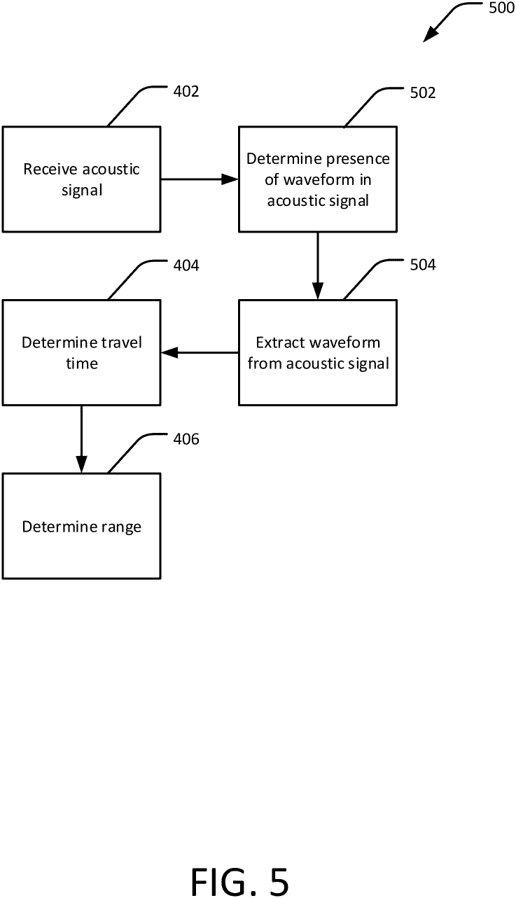

FIG. 5 is a flow diagram of another example method 500 for localizing an underwater vehicle using acoustic ranging, in accordance with an embodiment of the present disclosure. The method 500 is similar to the method 400 of FIG. 4, with the following differences. The method 500 includes determining 502, using the acoustic receiver, a presence of a known waveform in the acoustic signal by applying a replica correlation to the waveform. For instance, the known waveform is determined to be present in the acoustic signal if the output of the replica correlation, or a function thereof exceeds a signal detection, or signal matching, statistic or threshold value. The method 500 further includes extracting 504, using the acoustic receiver, the waveform from the acoustic signal using, for example, constant false alarm rate (CFAR) detection.

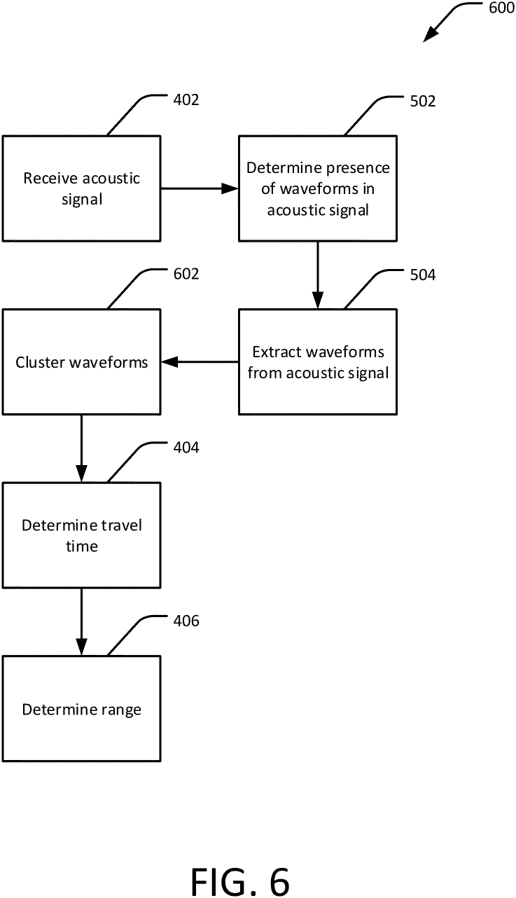

FIG. 6 is a flow diagram of another example method 600 for localizing an underwater vehicle using acoustic ranging, in accordance with an embodiment of the present disclosure. The method 600 is similar to the methods 400 and 500 of FIGS. 4 and 5, with the following differences. In some embodiments, the acoustic signal includes a plurality of waveforms. For example, the acoustic signal can be transmitted by several different acoustic sources, and each acoustic signal has a different waveform. By using at least two different acoustic sources, each having known locations, the acoustic receiver can triangulate the location of the vehicle in three dimensions (e.g., latitude, longitude, and depth) if the depth of the vehicle is known. In such cases, the method 600 includes clustering 602, using the acoustic receiver, the waveforms using a known waveform and a minimum allowed signal-to-noise ratio to produce a set of time delay estimates for each of the waveforms.

In some embodiments, determining 404 the travel time of the waveform includes subtracting a transmission start time of a known waveform from a reception start time of the waveform in the acoustic signal using a clock synchronized with the transmission start time. In some embodiments, determining 404 the travel time of the waveform includes determining a plurality of travel times of the waveform for each of a plurality of travel time instances, and multiplying each of the travel times of the waveform to the sound speed field estimate along the ray extending between the known location of the acoustic source and the acoustic receiver to obtain a plurality of ranges between the acoustic source and the acoustic receiver. In some embodiments, determining the three-dimensional location of the underwater vehicle includes determining a median of the plurality of ranges.

### Example System

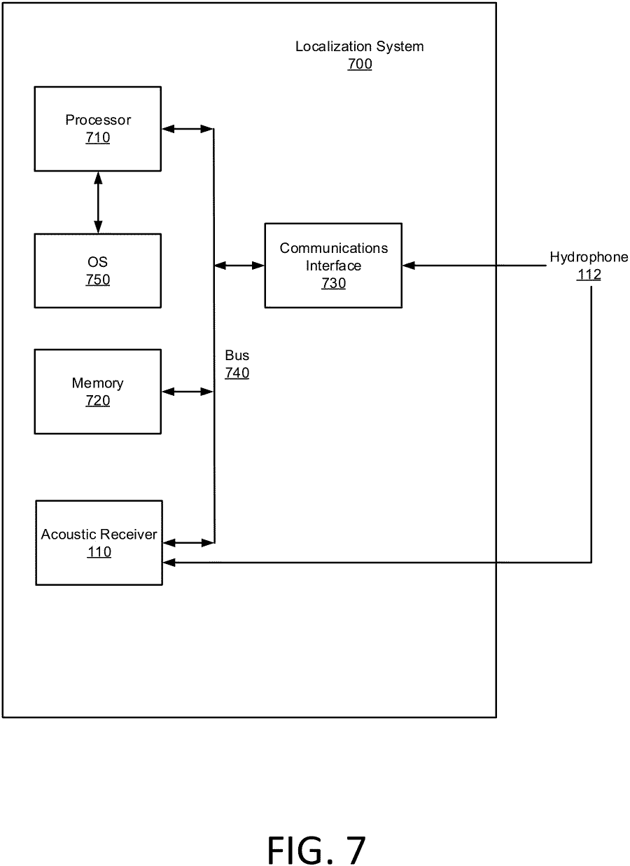

FIG. 7 is a block diagram of an example system 700 for localizing an underwater vehicle using acoustic ranging, in accordance with an embodiment of the present disclosure. In some embodiments, the system 700, or portions thereof, can be integrated with, hosted on, or otherwise be incorporated into a device configured to receive and process acoustic signals on the vehicle 110. In some embodiments, system 700 can include any combination of a processor 710, a memory 720, a communication interface 730, and the acoustic receiver 110. A communication bus 740 provides communications between the various components listed above, including the hydrophone 112, and/or other components not shown. Other componentry and functionality not reflected in FIG. 7 will be apparent in light of this disclosure, and it will be appreciated that other embodiments are not limited to any particular hardware configuration.

The processor 710 is configured to perform the functions of system 700, such as described above with respect to FIGS. 1-6. The processor 710 can be any suitable processor, and may include one or more coprocessors or controllers, such as an acoustic signal processor, to assist in control and processing operations associated with the vehicle 104. In some embodiments, the processor 710 can be implemented as any number of processor cores. The processor 710 (or processor cores) can be any type of processor, such as, for example, a micro-processor, an embedded processor, a digital signal processor (DSP), a graphics processor (GPU), a network processor, a field programmable gate array or other device configured to execute code. The processor 710 can include multithreaded cores in that they may include more than one hardware thread context (or “logical processor”) per core. The processor 710 can be implemented as a complex instruction set computer (CISC) or a reduced instruction set computer (RISC) processor. The memory 720 can be implemented using any suitable type of digital storage including, for example, flash memory and/or random-access memory (RAM). The memory 720 can be implemented as a volatile memory device such as a RAM, dynamic RAM (DRAM), or static RAM (SRAM) device.

The processor 710 can be configured to execute an operating system (OS) 750, such as Google Android (by Google Inc. of Mountain View, Calif.), Microsoft Windows (by Microsoft Corp. of Redmond, Wash.), Apple OS X (by Apple Inc. of Cupertino, Calif.), Linux, or a real-time operating system (RTOS). As will be appreciated in light of this disclosure, the techniques provided herein can be implemented without regard to the particular operating system provided in conjunction with the system 700, and therefore may also be implemented using any suitable existing systems or platforms. It will be appreciated that in some embodiments, some of the various components of the system 700 can be combined or integrated in a system-on-a-chip (SoC) architecture. In some embodiments, the components may be hardware components, firmware components, software components or any suitable combination of hardware, firmware or software.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional structures that include hardware, or a combination of hardware and software, and may comprise, for example, singly or in any combination, hardwired circuitry, programmable circuitry such as computer processors comprising one or more individual instruction processing cores, state machine circuitry, and/or gate level logic. The circuitry may include a processor and/or controller programmed or otherwise configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable device. In any such hardware cases that include executable software, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 provides a method of localizing an underwater vehicle using acoustic ranging includes receiving, using an acoustic receiver, a time series signal based on one or more acoustic signals transmitted from an acoustic source having a known location; determining, using a processor, a travel time of a waveform derived from the time series signal transmitted from the known location of the acoustic source to the acoustic receiver; and determining, using the processor, a range of the underwater vehicle with respect to the acoustic source based on the travel time of the waveform and a sound speed field taken along a ray trajectory extending from the known location of the acoustic source and intersecting with the acoustic receiver at an expected arrival time and depth of the acoustic signal at the underwater vehicle.

Example 2 includes the subj ect matter of Example 1, further including determining, using the processor, a presence of a known waveform in the acoustic signal by applying a replica correlation to the waveform.

Example 3 includes the subject matter of any one of Examples 1 and 2, further including extracting, using the processor, the waveform from the acoustic signal using a constant false alarm rate (CFAR) detector.

Example 4 includes the subject matter of any one of Examples 1-3, wherein the acoustic signal includes a plurality of waveforms, and wherein the method further includes clustering, using the processor, the waveforms using a known waveform and a minimum allowed signal-to-noise ratio to produce a set of time delay estimates for each of the waveforms.

Example 5 includes the subject matter of any one of Examples 1-4, wherein determining the travel time of the waveform comprises subtracting a transmission start time of a known waveform from a reception start time of the waveform in the acoustic signal using a clock synchronized with the transmission start time.

Example 6 includes the subject matter of any one of Examples 1-5, wherein determining the travel time of the waveform comprises determining a plurality of travel times of the waveform for each of a plurality of travel time instances, and wherein the method further comprises determining, using the processor, a plurality of ranges of the underwater vehicle with respect to the acoustic source based on the plurality of travel times of the waveform and the sound speed field taken along the ray trajectory.

Example 7 includes the subject matter of Example 6, wherein determining the range of the underwater vehicle comprises determining a median of the plurality of ranges.

Example 8 includes the subject matter of any one of Examples 1-7, wherein the waveform is configured to uniquely identify the acoustic source.

Example 9 provides an underwater vehicle localization system including a hydrophone; an acoustic receiver configured to receive an acoustic signal via the hydrophone; and at least one processor coupled to the acoustic receiver and configured to execute a process for localizing an underwater vehicle using acoustic ranging, the process comprising: receiving, using an acoustic receiver, a time series signal based on one or more acoustic signals transmitted from an acoustic source having a known location; determining a travel time of a waveform derived from the time series signal transmitted from the known location of the acoustic source to the acoustic receiver; and determining a range of the underwater vehicle with respect to the acoustic source based on the travel time of the waveform and a sound speed field taken along a ray trajectory extending from the known location of the acoustic source and intersecting with the acoustic receiver at an expected arrival time and depth of the acoustic signal at the underwater vehicle.

Example 10 includes the subject matter of Example 9, wherein the process further includes determining a presence of a known waveform in the acoustic signal by applying a replica correlation to the waveform.

Example 11 includes the subject matter of any one of Examples 9 and 10, wherein the process further includes extracting the waveform from the acoustic signal using a constant false alarm rate (CFAR) detector.

Example 12 includes the subject matter of any one of Examples 9-11, wherein the acoustic signal includes a plurality of waveforms, and wherein the process further includes clustering the waveforms using a known waveform and a minimum allowed signal-to-noise ratio to produce a set of time delay estimates for each of the waveforms.

Example 13 includes the subject matter of any one of Examples 9-12, wherein determining the travel time of the waveform comprises subtracting a transmission start time of a known waveform from a reception start time of the waveform in the acoustic signal using a clock synchronized with the transmission start time.

Example 14 includes the subject matter of any one of Examples 9-13, wherein determining the travel time of the waveform comprises determining a plurality of travel times of the waveform for each of a plurality of travel time instances, and wherein the process further includes determining a plurality of ranges of the underwater vehicle with respect to the acoustic source based on the plurality of travel times of the waveform and the sound speed field taken along the ray trajectory.

Example 15 includes the subject matter of Example 14, wherein determining the range of the underwater vehicle comprises determining a median of the plurality of ranges.

Example 16 provides a computer program product including one or more non-transitory machine-readable mediums encoded with instructions that when executed by one or more processors cause a process to be carried out for localizing an underwater vehicle using acoustic ranging, the process including receiving, using an acoustic receiver, a time series signal based on one or more acoustic signals transmitted from an acoustic source having a known location; determining a travel time of a waveform derived from the time series signal transmitted from the known location of the acoustic source to the acoustic receiver; and determining a range of the underwater vehicle with respect to the acoustic source based on the travel time of the waveform and a sound speed field taken along a ray trajectory extending from the known location of the acoustic source and intersecting with the acoustic receiver at an expected arrival time and depth of the acoustic signal at the underwater vehicle.

Example 17 includes the subject matter of Example 16, wherein the process further includes determining a presence of a known waveform in the acoustic signal by applying a replica correlation to the waveform.

Example 18 includes the subject matter of any one of Examples 16 and 17, wherein the process further includes extracting the waveform from the acoustic signal using a constant false alarm rate (CFAR) detector.

Example 19 includes the subject matter of any one of Examples 16-18, wherein the acoustic signal includes a plurality of waveforms, and wherein the process further includes clustering the waveforms using a known waveform and a minimum allowed signal-to-noise ratio to produce a set of time delay estimates for each of the waveforms.

Example 20 includes the subject matter of any one of Examples 16-19, wherein determining the travel time of the waveform comprises subtracting a transmission start time of a known waveform from a reception start time of the waveform in the acoustic signal using a clock synchronized with the transmission start time.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A method of localizing an underwater vehicle using acoustic ranging, the method comprising:
receiving, using an acoustic receiver, a time series signal based on one or more acoustic signals transmitted from an acoustic source having a known location;
determining, using a processor, a travel time of a waveform derived from the time series signal transmitted from the known location of the acoustic source to the acoustic receiver; and
determining, using the processor, a range of the underwater vehicle with respect to the acoustic source based on the travel time of the waveform and a sound speed field taken along a ray trajectory extending from the known location of the acoustic source and intersecting with the acoustic receiver at an expected arrival time and depth of the acoustic signal at the underwater vehicle.

2. The method of claim 1, further comprising determining, using the processor, a presence of a known waveform in the acoustic signal by applying a replica correlation to the waveform.

3. The method of claim 1, further comprising extracting, using the processor, the waveform from the acoustic signal using a constant false alarm rate (CFAR) detector.

4. The method of claim 1, wherein the acoustic signal includes a plurality of waveforms, and wherein the method further comprises clustering, using the processor, the waveforms using a known waveform and a minimum allowed signal-to-noise ratio to produce a set of time delay estimates for each of the waveforms.

5. The method of claim 1, wherein determining the travel time of the waveform comprises subtracting a transmission start time of a known waveform from a reception start time of the waveform in the acoustic signal using a clock synchronized with the transmission start time.

6. The method of claim 1, wherein determining the travel time of the waveform comprises determining a plurality of travel times of the waveform for each of a plurality of travel time instances, and wherein the method further comprises determining, using the processor, a plurality of ranges of the underwater vehicle with respect to the acoustic source based on the plurality of travel times of the waveform and the sound speed field taken along the ray trajectory.

7. The method of claim 6, wherein determining the range of the underwater vehicle comprises determining a median of the plurality of ranges.

8. The receiver of claim 1, wherein the waveform is configured to uniquely identify the acoustic source.

9. An underwater vehicle localization system comprising:
a hydrophone;
an acoustic receiver configured to receive an acoustic signal via the hydrophone; and
at least one processor coupled to the acoustic receiver and configured to execute a process for localizing an underwater vehicle using acoustic ranging, the process comprising:
receiving, using an acoustic receiver, a time series signal based on one or more acoustic signals transmitted from an acoustic source having a known location;
determining a travel time of a waveform derived from the time series signal transmitted from the known location of the acoustic source to the acoustic receiver; and
determining a range of the underwater vehicle with respect to the acoustic source based on the travel time of the waveform and a sound speed field taken along a ray trajectory extending from the known location of the acoustic source and intersecting with the acoustic receiver at an expected arrival time and depth of the acoustic signal at the underwater vehicle.

10. The system of claim 9, wherein the process further comprises determining a presence of a known waveform in the acoustic signal by applying a replica correlation to the waveform.

11. The system of claim 9, wherein the process further comprises extracting the waveform from the acoustic signal using a constant false alarm rate (CFAR) detector.

12. The system of claim 9, wherein the acoustic signal includes a plurality of waveforms, and wherein the process further comprises clustering the waveforms using a known waveform and a minimum allowed signal-to-noise ratio to produce a set of time delay estimates for each of the waveforms.

13. The system of claim 9, wherein determining the travel time of the waveform comprises subtracting a transmission start time of a known waveform from a reception start time of the waveform in the acoustic signal using a clock synchronized with the transmission start time.

14. The system of claim 9, wherein determining the travel time of the waveform comprises determining a plurality of travel times of the waveform for each of a plurality of travel time instances, and wherein the process further comprises determining a plurality of ranges of the underwater vehicle with respect to the acoustic source based on the plurality of travel times of the waveform and the sound speed field taken along the ray trajectory.

15. The system of claim 14, wherein determining the range of the underwater vehicle comprises determining a median of the plurality of ranges.

16. A computer program product including one or more non-transitory machine-readable mediums encoded with instructions that when executed by one or more processors cause a process to be carried out for localizing an underwater vehicle using acoustic ranging, the process comprising:
receiving, using an acoustic receiver, a time series signal based on one or more acoustic signals transmitted from an acoustic source having a known location;
determining a travel time of a waveform derived from the time series signal transmitted from the known location of the acoustic source to the acoustic receiver; and
determining a range of the underwater vehicle with respect to the acoustic source based on the travel time of the waveform and a sound speed field taken along a ray trajectory extending from the known location of the acoustic source and intersecting with the acoustic receiver at an expected arrival time and depth of the acoustic signal at the underwater vehicle.

17. The computer program product of claim 16, wherein the process further comprises determining a presence of a known waveform in the acoustic signal by applying a replica correlation to the waveform.

18. The computer program product of claim 16, wherein the process further comprises extracting the waveform from the acoustic signal using a constant false alarm rate (CFAR) detector.

19. The computer program product of claim 16, wherein the acoustic signal includes a plurality of waveforms, and wherein the process further comprises clustering the waveforms using a known waveform and a minimum allowed signal-to-noise ratio to produce a set of time delay estimates for each of the waveforms.

20. The computer program product of claim 16, wherein determining the travel time of the waveform comprises subtracting a transmission start time of a known waveform from a reception start time of the waveform in the acoustic signal using a clock synchronized with the transmission start time.
